(19) United States
(12) Patent Application Publication
(10) Pub. No.: US 2010/0142074 A1
(43) Pub. Date: Jun. 10, 2010

(54) HEAD EVALUATING METHOD AND DEVICE, AND INFORMATION STORAGE APPARATUS

(76) Inventor: Kojiro MITOH, Tokyo (JP)

Correspondence Address: KNOBBE MARTENS OLSON & BEAR LLP, 2040 MAIN STREET, FOURTEENTH FLOOR, IRVINE, CA, 92614, US

(21) Appl. No.: 12/631,727

(22) Filed: Dec. 4, 2009

(30) Foreign Application Priority Data
Dec. 5, 2008 (JP) 2008-310811

(51) Int. Cl. G11B 27/36

(52) U.S. Cl. 360/31; G9B/27.052

(57) ABSTRACT

According to one embodiment, a method evaluates a head comprising a read element, a recording element, a coil, and a heater to change a projection amount of the elements by thermal expansion. The method includes: floating the head over the medium rotated; projecting including conducting electricity through the heater with an electric power, and projecting the elements toward the medium; first recording including stopping the conduction, and recording data in a sector on the medium after the stopping; second recording of recording data in another sector on the medium; reproducing the recorded data to obtain their reproducing characteristics; and obtaining including repeating the projecting, first and second recording, and reproducing, while changing the electric power in the projecting, obtaining the electric power for the heater at which the characteristics equal each other to compute the projection amount due to a current fed through the coil upon recording.

### CROSS-REFERENCE TO RELATED APPLICATIONS

This application is based upon and claims the benefit of priority from Japanese Patent Application No. 2008-310811, filed Dec. 5, 2008, the entire contents of which are incorporated herein by reference.

### BACKGROUND

1. Field

One embodiment of the invention relates to a head evaluating method, a head evaluating device, and an information storage apparatus, and particularly to a method of evaluating a head comprising a read element, a recording element, a recording coil, and a heater, a device for evaluating the head, and an information storage apparatus that performs the method. A recording current is fed through the recording coil upon recording. The heater changes a projection amount of the read element and recording element with respect to a medium by thermal expansion caused by electric heating.

2. Description of the Related Art

An example of known heads includes a read element, a recording element, a recording coil through which a recording current is fed upon recording, and a heater that changes a projection amount of the read element and recording element with respect to a medium by thermal expansion caused by electric heating.

A technique is known, which sets an optimum heater control value by calibration with suppressed degradation in characteristics of the head caused by thermal expansion due to a recording current immediately after start of recording (Japanese Patent Application Publication (KOKAI) No. 2008-112515).

As used herein, a “projection amount upon recording” refers to an amount of projection of a read element and a recording element with respect to a medium by a recording current fed through a recording coil.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view illustrating a magnetic disk device including a magnetic head that is of an evaluation target of a head evaluating device;

FIG. 2A is an exemplary enlarged perspective view illustrating a head gimbal assembly comprised in the magnetic disk device of FIG. 1;

FIG. 2B is an exemplary side sectional view illustrating a slider comprised in the head gimbal assembly of FIG. 2A;

FIG. 2C is an exemplary partially enlarged perspective view illustrating part of the slider of FIG. 2B;

FIG. 3 is an exemplary block diagram illustrating a schematic configuration of an example of an embodiment of a head evaluating device;

FIG. 4 is an exemplary view (part 1) illustrating an outline of a head evaluating method performed by the head evaluating device in the embodiment;

FIG. 5 is an exemplary view (part 2) illustrating the outline of the head evaluating method performed by the head evaluating device in the embodiment;

FIG. 6 is an exemplary flowchart illustrating an operation flow in the head evaluating method performed by the head evaluating device in the embodiment;

FIG. 7 is an exemplary view of a touchdown profile;

FIG. 8 is an exemplary block diagram illustrating a magnetic disk device that is of an embodiment of an information storage apparatus;

FIGS. 9A to 9D are exemplary views (part 1) illustrating experimental data of the head evaluating device in the embodiment; and

FIGS. 10A to 10E are exemplary views (part 2) illustrating the experimental data of the head evaluating device in the embodiment.

### DETAILED DESCRIPTION

Various embodiments according to the invention will be described hereinafter with reference to the accompanying drawings. In general, according to one embodiment of the invention, a head evaluating method is for evaluating a head comprising a read element, a recording element, a recording coil through which a recording electric current is fed upon recording performed by the read element, and a heater configured to change a projection amount of the read element and recording element with respect to a medium by thermal expansion caused by electric heating. The head evaluating method comprises: floating the head over the medium rotated; projecting including conducting electricity through the heater with a predetermined electric power, and projecting the read element and the recording element toward the medium; first recording including stopping the conduction of electricity through the heater, and recording data in a first sector on the medium after the stopping of the conduction of electricity; second recording of recording data in a second sector on the medium that is away from the first sector by a predetermined sector or sectors; reproducing the data recorded in the first sector and second sector to obtain a reproducing characteristic of the data recorded in the first sector and a reproducing characteristic of the data recorded in the second sector; and obtaining of a projection amount upon recording, including: repeating the projecting, the first recording, the second recording, and the reproducing, while changing the predetermined electric power in the projecting, obtaining the predetermined electric power for the heater at which the reproducing characteristic of the first sector equals the reproducing characteristic of the second sector, and computing, based on the obtained electric power, a projection amount of the read element and recording element with respect to the medium due to the recording electric current fed through the recording coil upon recording.

According to another embodiment of the invention, a head evaluating device is configured to evaluate a head comprising a read element, a recording element, a recording coil through which a recording electric current is fed upon recording performed by the read element, and a heater configured to change a projection amount of the read element and recording element with respect to a medium by thermal expansion caused by electric heating. The head evaluating device comprises: a heater power controller configured to conduct electricity thorough the heater; a reproducing and recording controller configured to reproduce data from the medium or record data on the medium, using the head; and a projection-amount-upon-recording obtaining module configured to obtain a projection amount of the read element and recording element with respect to the medium due to the recording electric current fed through the recording coil upon recording; wherein the projection-amount-upon-recording obtaining module is configured to stop the conduction of electricity through the heater after causing the heater power controller to conduct electricity through the heater with a predetermined electric power to project the read element and recording element toward the medium, cause the reproducing and recording controller to record data in a first sector on the medium after the stopping of the conduction of electricity and in a second sector away from the first sector by a predetermined sector or sectors, and reproduce the data recorded in the first sector and second sector to obtain a reproducing characteristic of the first sector and a reproducing characteristic of the second sector, and obtain the predetermined electric power for the heater at which the reproducing characteristic of the first sector equals the reproducing characteristic of the second sector, and compute, based on the obtained electric power, the projection amount of the read element and recording element with respect to the medium due to the recording electric current fed through the recording coil upon recording.

According to still another embodiment of the invention, an information storage apparatus includes a head comprising a read element, a recording element, a recording coil through which a recording electric current is fed upon recording performed by the read element, and a heater configured to change a projection amount of the read element and recording element by thermal expansion caused by electric heating. The head evaluating device comprises: a heater power controller configured to conduct electricity thorough the heater; a reproducing and recording controller configured to reproduce data from a medium or record data on the medium, using the head; and a projection-amount-upon-recording obtaining module configured to obtain a projection amount of the read element and recording element with respect to the medium due to the recording electric current fed through the recording coil upon recording; wherein the projection-amount-upon-recording obtaining module is configured to stop the conduction of electricity through the heater after causing the heater power controller to conduct electricity through the heater with a predetermined electric power to project the read element and recording element toward the medium, cause the reproducing and recording controller to record data in a first sector on the medium after the stopping of the conduction of electricity and in a second sector away from the first sector by a predetermined sector or sectors, and reproduce the data recorded in the first sector and second sector to obtain a reproducing characteristic of the first sector and a reproducing characteristic of the second sector, and obtain the predetermined electric power for the heater at which the reproducing characteristic of the first sector equals the reproducing characteristic of the second sector, and compute, based on the obtained electric power, the projection amount of the read element and recording element with respect to the medium due to the recording electric current fed through the recording coil upon recording.

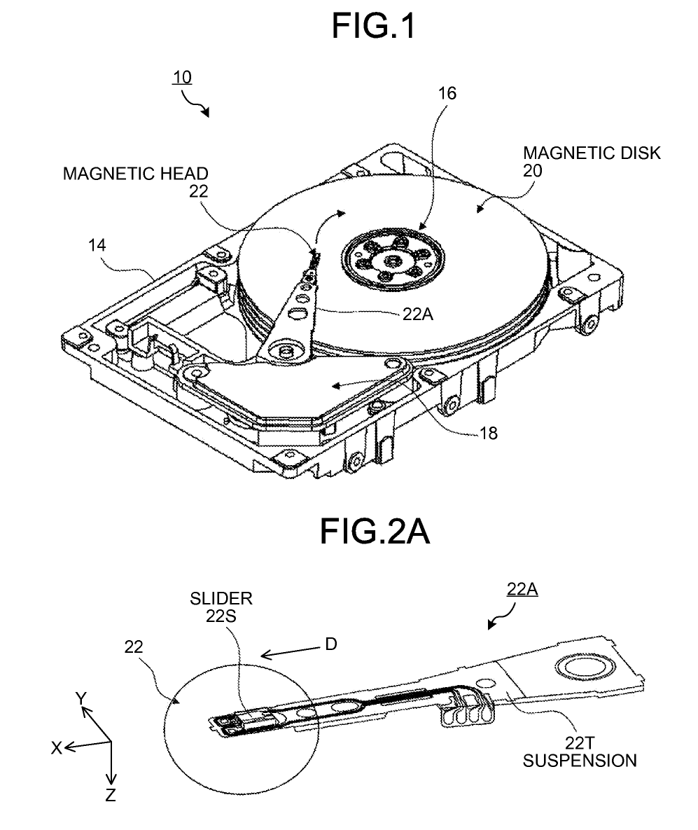

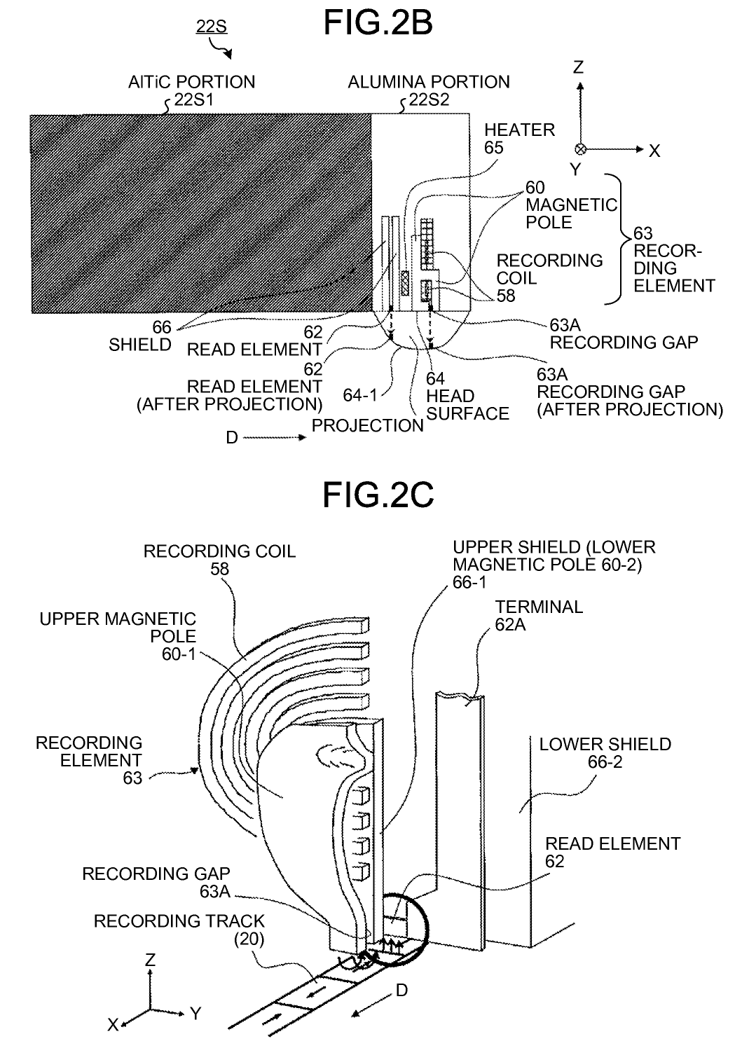

FIG. 1 is a perspective view illustrating a magnetic disk device including a magnetic head that is of an evaluation target of an embodiment of a head evaluating device. FIG. 2A is an enlarged perspective view illustrating a head gimbal assembly comprised in the magnetic disk device of FIG. 1. FIG. 2B is a side sectional view illustrating a slider comprised in the head gimbal assembly of FIG. 2A. FIG. 2C is a partially enlarged perspective view illustrating part of the slider of FIG. 2B. A front portion is cut out in FIG. 2C in order to easily understand a head structure. In FIGS. 2A, 2B, and 2C, the letter D designates a rotating direction of a disk 20.

Referring to FIG. 1, a magnetic disk device 10 comprises the magnetic head that is of the evaluation target of the embodiment of the head evaluating device, and the magnetic disk device 10 comprises a magnetic disk (hereinafter simply referred to as “disk”) 20 that is of an information recording medium (sometimes simply referred to as “medium”). The magnetic disk device 10 also comprises a magnetic head (hereinafter simply referred to as “head”) 22. The head 22 records information in the disk 20, and the head 22 reads the information from the disk 20. The head 22 is provided at a leading end of a head gimbal assembly 22A, and a voice coil motor 18 turns the head gimbal assembly 22A. The head 22 is positioned at any radial position on the disk 20 by turning the head gimbal assembly 22A. A spindle motor 16 rotates the disk 20 at high speed to generate a stream of air on the disk 20. The head 22 provided at the leading end of the head gimbal assembly 22A floats on the disk 20 by the stream of air. The head 22 records the information in the disk 20 while floating on the disk 20, and the head 22 reads the information from the disk 20 while floating on the disk 20.

As illustrated in FIG. 2A, the head gimbal assembly 22A comprises an elastic suspension 22T and a slider 22S that is attached to a leading end of the suspension 22T. The slider 22S constitutes the head 22.

As illustrated in FIG. 2B, the slider 22S comprises an AlTiC portion 22S1 and an alumina portion 22S2. The alumina portion 22S2 comprises a magnetic pole 60, a recording coil 58 that is wound on the magnetic pole 60, and a recording gap 63A that is provided at a leading end of the magnetic pole 60. The slider 22S also comprises a shield 66 and a read element 62 that is attached to a leading end of the shield 66. The slider 22S also comprises a heater 65. A combination of the magnetic pole 60 and the recording coil 58 constitutes a recording element 63. For example, the read element 62 comprises a well-known GMR element or TMR element.

In the head 22 having the structure of the slider 22S, an Air Bearing Surface (ABS) (hereinafter referred to as “head surface”) 64 in which the recording element 63 and the read element 62 are provided faces the disk 20 that is of the medium. When the recording current is passed through the recording coil 58 while the head surface 64 faces the disk 20, a magnetic field is generated from the recording gap 63A provided at the leading end of the magnetic pole 60 according to the recording current, and the magnetic field acts on a recording layer (not illustrated) of the disk 20. Accordingly, the magnetic field magnetizes the recording layer, whereby the head 20 magnetically records the information in the disk 20. The disk 20 in which the information is recorded generates a magnetic field corresponding to the recording contents, and the read element 62 detects the magnetic field, whereby the head 22 magnetically reads the information from the disk 20.

When the head 22 records the information in the disk 20, the recording current is passed through the recording coil 58, and the recording coil 58 generates heat by Joule heat. The alumina portion 22S2 of the head 22 thermally expands by the heating of the heat generation, and the head surface 64 projects toward the side of the disk 20, that is, a downward direction of FIG. 2B. In FIG. 2B, the numeral 64-1 designates the state in which the head surface 64 projects. The projection of the head surface 64 brings the read element 62 and the recording element 63, provided in the head surface 64, close to the disk 20. In FIG. 2B, the read element (after projection) 62 and the recording gap (after projection) 63A designate positions of the read element 62 and the recording gap 63A, which come close to the disk 20 as a result of the projection of each head surface 64. The read element 62 and the recording element 63 come close to the disk 20 to decrease a distance between the disk 20 and the head surface 64 of the head 22 (hereinafter simply referred to as “floating amount”).

When the head 22 reads the information from the disk 20, the recording current is not passed through the recording coil 58, but the heater 65 is energized. When the heater 65 is energized, the heater 65 generates the heat by Joule heat. As with the energization of the recording coil 58, the alumina portion 22S2 of the head 22 thermally expands by the heating of the heat generation, and the head surface 64 projects toward the side of the disk 20, that is, the downward direction of FIG. 2B. The read element 62 and the recording element 63, which are provided in the head surface 64, come close to the disk 20 as a result of the projection of the head surface 64. The read element 62 and the recording element 63 come close to the disk 20 to decrease the floating amount of the head 22. The read element 62 is electrically connected to an external circuit through a terminal 62A to withdraw a read signal.

As illustrated in FIG. 2C, the magnetic pole 60 comprised in the alumina portion 22S2 comprises an upper magnetic pole 60-1 and a lower magnetic pole 60-2 in the order from an X-direction. The shield 66 comprises an upper shield 66-1, an intermediate shield (not illustrated in FIG. 2C), and a lower shield 66-2 in the order from the X-direction. The read element 62 is inserted and attached between the upper shield 66-1 and the intermediate shield.

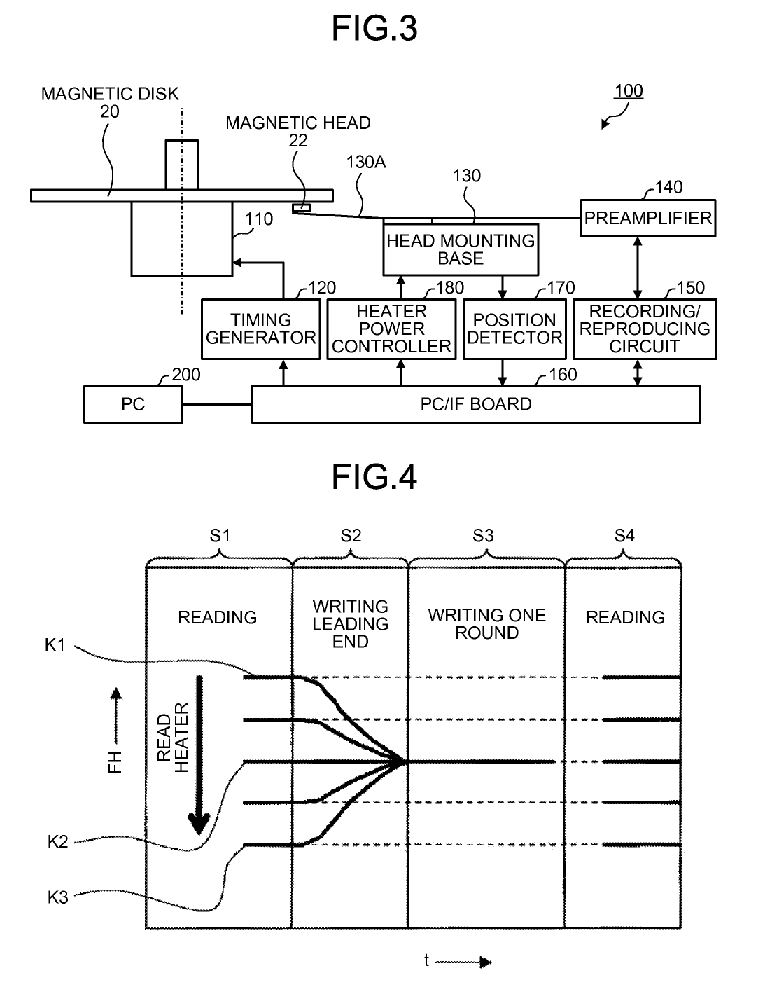

FIG. 3 is a block diagram illustrating a head evaluating device 100 that is an example of the embodiment of the head evaluating device.

The head evaluating device 100 comprises a spindle motor 110. The spindle motor 110 supports the disk 20 of FIG. 1, and the spindle motor 110 rotates the disk 20 at high speed like the spindle motor 16 of FIG. 1. The head evaluating device 100 comprises a head mounting base 130. The head mounting base 130 supports the head 22 of FIG. 2B by a head gimbal assembly 130A that is similar to the head gimbal assembly 22A of FIG. 2A.

The head evaluating device 100 also comprises a preamplifier 140 and a recording/reproducing circuit 150. The preamplifier 140 amplifies a signal having the information that should be recorded in the disk 20 or a signal having the information read from the disk 20. The recording/reproducing circuit 150 is connected to the preamplifier 140, and the recording/reproducing circuit 150 generates the signal having the information that should be recorded in the disk 20 or reproduces the signal having the information read from the disk 20.

The head evaluating device 100 also comprises a position detector 170, a heater power controller 180, and a timing generator 120. The position detector 170 detects a position of the head 22 on the disk 20 using positional information obtained from the disk 20 through the head 22. The heater power controller 180 control an electric power supplied to the heater 65 of the head 22. The timing generator 120 generates a timing signal in order to control the number of rotations of the spindle motor 110. The recording/reproducing circuit 150, the position detector 170, the heater power controller 180, and the timing generator 120 are connected to a personal computer 200 through a PC/IF (that is, interface) board 160. Configurations of the recording/reproducing circuit 150, the position detector 170, the heater power controller 180, and the timing generator 120 are similar to those of corresponding functional portions of the well-known hard disk drive.

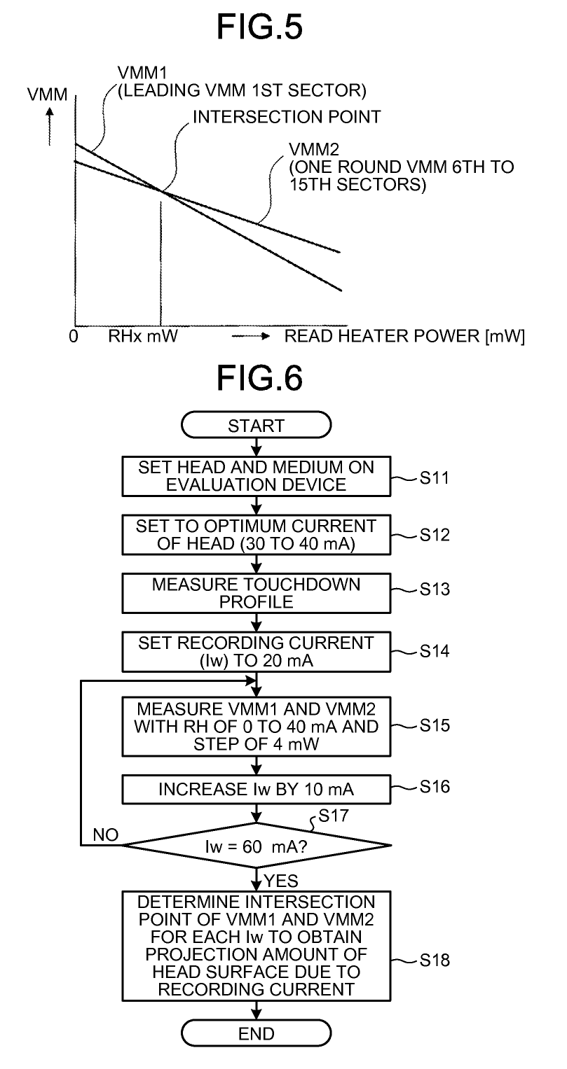

A head evaluating method performed by the head evaluating device 100 will schematically be described with reference to FIGS. 4 and 5. In FIG. 4, a horizontal axis indicates passage of time (t), and a vertical axis indicates a floating amount (FH) of the head surface 64 from the recording surface of the disk 20.

Referring to FIG. 4, at S1, the heater 65 of the head 22 is energized. At S2, the head 22 records data in a leading-end first sector in a recording track of the disk 20 while the energization of the heater 65 is stopped. At S3, the head 22 records the pieces of data in sixth to fifteenth sectors in the recording track. At S4, the head 22 reads the pieces of data that are written in the recording track of the disk 20 at S2 and S3. The operations at S1 to S4 are repeated plural times while the electric power supplied to the heater 65 at S1 is varied.

In FIG. 4, the numeral K1 illustrates the case in which the electric power supplied to the heater 65 at S1 is 0 mW. At this point, at S1, because neither the heater 65 nor the recording coil 58 is energized, the head surface 64 does not project. Accordingly, at S1, the floating amount (FH) becomes large as illustrated in FIG. 4. At S2, because the data is recorded, the recording coil 58 is energized. The conduction of electricity through the recording coil 58 heats the alumina portion 22S2 of the head 22 to generate the thermal expansion, and the head surface 64 projects gradually, thereby gradually decreasing the floating amount (FH) as illustrated in FIG. 4. When the floating amount is decreased, the distance between the head surface 64 and the recording surface of the disk 20 shortens to increase the magnetic action of the recording element 63 on the disk 20, whereby a reproducing characteristic of the data recorded in the disk 20 by the recording element 63 of the head 22 is gradually improved with decreasing floating amount. When the data is further recorded at S3, the projection of the head surface 64 substantially stabilizes in the decreased state, and the floating amount (FH) is substantially kept constant at S3 as illustrated in FIG. 4. In the case K1, the floating amount at S3 is smaller than the floating amount at S2. Therefore, the reproducing characteristic of the data recorded at S3 is better than the reproducing characteristic of the data recorded at S2.

In FIG. 4, the numeral K3 illustrates the case in which the electric power supplied to the heater 65 at S1 is RHm (mW). At this point, at S1, the alumina portion 22S2 of the head 22 is heated to generate the thermal expansion by the energization of the heater 65, and the head surface 64 projects. Accordingly, at S1, the floating amount (FH) becomes small as illustrated in FIG. 4. At S2, because the data is recorded although the energization of the heater 65 is stopped, the energization of the recording coil 58 is started. Accordingly, the alumina portion 22S2 of the head 22 is heated to generate the thermal expansion by the energization of the recording coil 58, the head surface 64 projects. In the case K3, because the heating amount by the energization of the heater 65 at S1 is larger than the heating amount by the energization of the recording coil 58 at S2, the projection amount of the head surface 64 at S1 is smaller than the projection amount of the head surface 64 at S2. Accordingly, in the case K3, the floating amount (FH) is gradually increased at S2. When the floating amount is increased, the distance between the recording element 63 and the recording surface of the disk 20 lengthens to decrease the magnetic action of the recording element 63 on the disk 20, whereby the reproducing characteristic of the data recorded in the disk 20 by the recording element 63 of the head 22 degrades gradually with increasing floating amount. When the data is further recorded at S3, the projection of the head surface 64 substantially stabilizes in the increased state, and the floating amount (FH) is substantially kept constant at S3 as illustrated in FIG. 4. In the case K3, the floating amount at S3 is larger than the floating amount at S2. Therefore, the reproducing characteristic of the data recorded at S3 degrades compared with the reproducing characteristic of the data recorded at S2.

In FIG. 4, the numeral K2 illustrates the case in which the electric power supplied to the heater 65 at S1 is RHx (mW). At this point, at S1, the alumina portion 22S2 of the head 22 is heated to generate the thermal expansion by the energization of the heater 65, and the head surface 64 projects. Accordingly, at S1, the floating amount (FH) lies between the case K1 and the case K3 as illustrated in FIG. 4. At S2, because the data is recorded although the energization of the heater 65 is stopped, the energization of the recording coil 58 is started. The conduction of electricity through the recording coil 58 heats the alumina portion 22S2 of the head 22 to generate the thermal expansion, and the head surface 64 projects gradually, thereby generating the production of the head surface 64. In the case K2, because an influence of the heating by the energization of the heater 65 at S1 is substantially equal to an influence of the heating by the energization of the recording coil 58 at S2, the projection amount of the head surface 64 at S1 becomes equal to the projection amount of the head surface 64 at S2. Accordingly, in the case K2, the floating amount (FH) is substantially kept constant at S2 as illustrated in FIG. 4. When the floating amount is substantially kept constant, the distance between the head surface 64 and the recording surface of the disk 20 is substantially kept constant, and the magnetic action of the recording element 63 on the disk 20 is substantially kept constant. As a result, the reproducing characteristic of the data recorded in the disk 20 by the recording element 63 of the head 22 is substantially kept constant. When the data is further recorded at S3, the projections of the recording element 63 and the read element 62 substantially stabilize, and the floating amount (FH) is substantially kept constant at S3 as illustrated in FIG. 4. In the case K2, the floating amount at S2 is substantially equal to the floating amount at S3. Therefore, the reproducing characteristic of the data recorded at S2 is substantially equal to the reproducing characteristic of the data recorded at S3.

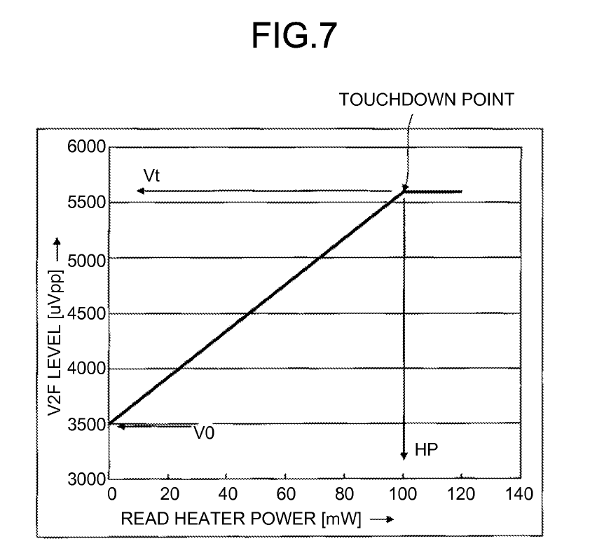

In the embodiment, the state K2 is obtained. As described above, in the state K2, the floating amount at S2 is substantially equal to the floating amount at S3. The reproducing characteristic of the data recorded at S2 is substantially equal to the reproducing characteristic of the data recorded at S3. Therefore, the electric power of the heater 65 at S1 is obtained when the reproducing characteristic of the data recorded at S2 is substantially equal to the reproducing characteristic of the data recorded at S3, that is, in the case K2. In the state K2, the floating amount of the projection caused by the energization of the recording coil 58 at S3 is substantially equal to the floating amount of the projection caused by the energization of the heater 65 at S2. When the floating amount in the state K2 is obtained, the obtained floating amount is substantially equal to the floating amount of the projection caused by the energization of the recording coil 58. Therefore, a moving amount of the head surface 64 with respect to a unit variation in electric power upon conducting electricity through the heater 65 is previously obtained from a touchdown profile of FIG. 7. When the reproducing characteristic of the data recorded at S2 is substantially equal to the reproducing characteristic of the data recorded at S3, the projection amount is obtained from the moving amount of the head surface 64 with respect to the unit variation in electric power of the energization of the heater 65. That is, the projection amount is obtained when the energization of the heater 65 at S1 in the state K2. As described above, the obtained projection amount is substantially equal to the projection amount caused by the energization of the recording coil 58, that is, the projection amount in the recording.

Although S1 to S4 are repeated in the three states K1, K3, and K2, that is, three times in FIG. 4, actually S1 to S4 are repeated at least four times when the electric power of the heater 65 at S1 varies. As a result, the case in which the reproducing characteristic of the data recorded at S2 is substantially equal to the reproducing characteristic of the data recorded at S3, that is, the state K2 can accurately be obtained. As a result, the electric power of the heater 65 at S1 can accurately be obtained when the floating amount of the projection caused by the energization of the recording coil 58 at S3 is substantially equal to the floating amount of the projection caused by the energization of the heater 65 at S2. As a result, the projection amount in the recording can accurately be obtained.

FIG. 5 illustrates a relationship between the electric power of the heater 65 and the reproducing characteristic of the recorded data, obtained by repeating S1 to S4 many times, when the electric power of the heater 65 at S1 is varied, as illustrated in FIG. 4. In FIG. 5, the horizontal axis indicates the electric power (mW) of the heater 65 at S1, and the vertical axis indicates the reproducing characteristic of the data recorded at S2 or S3. At this point, a well-known Viterbi Metric Margin (VMM) is used as the reproducing characteristic. That is, pieces of data are respectively recorded in a leading-end sector (in the embodiment, first sector) in one recording track of the disk and a sector (in the embodiment, sixth to fifteenth sectors) from a predetermined-sector distance to obtain VMMs of the sectors, that is, VMM1 and VMM2. The method is called “leading-end and round-average method”. Reliability of the obtained projection amount in the recording can be enhanced by adopting the “leading-end and round-average method”.

In the leading-end and round-average method, as illustrated in FIG. 4, the electric power of the energization of the heater 65 at S1 is changed in a stepwise manner from 0 mW (that is, the state K1) to a certain value (that is, the state K3). The flow of S1 to S4 is performed in each electric power of the energization of the heater 65. In each state, VMM1 that is of VMM of the data recorded at S2 and VMM2 that is of VMM of the data recorded at S3 are reproduced at S4 and measured. As described above, VMMI is the value of the first sector, and VMM2 is the value of a sector near the first sector, that is, the values of the sixth to fifteenth sectors so as not to be affected by an in-plane variation of the medium as much as possible. One round of the recording track of the disk 20 has the total of 256 sectors. In FIG. 5, the state K2 in which the projection amounts are substantially equal to each other is an intersection point (that is, RHx (mW)) of VMM1 and VMM2. The electric power of the energization of the heater 65 at the intersection point is converted into the projection amount (nm), which allows the projection amount in the recording to be obtained.

The reason the projection amount is measured in the recording will be described below. That is, 1) the projection amount in the recording is obtained to use the projection amount as data for improving the head, and 2) in shipping the magnetic disk device, the projection amount in the recording is obtained to evaluate a characteristic of the head mounted on the magnetic disk device.

The reproducing characteristic is not limited to VMM. For example, an error rate may be used as the reproducing characteristic. A reproducing output may be used as the reproducing characteristic.

A method for obtaining the electric power of the energization of the heater 65 in the case where the reproducing characteristic of the first sector and the reproducing characteristics of the sixth to fifteenth sectors are equal to each other will be described below. Actually, when a difference between the reproducing characteristic of the first sector and the reproducing characteristics of the sixth to fifteenth sectors is equal to or lower than a predetermined value, it can be determined that the reproducing characteristic of the first sector and the reproducing characteristics of the sixth to fifteenth sectors are equal to each other. Alternatively, the following method may be adopted. Alternatively, as illustrated in FIG. 5, the reproducing characteristic of the first sector and the reproducing characteristics of the sixth to fifteenth sectors are linearly approximated, respectively. The electric power of the energization of the heater 65 may be obtained at the intersection point of the straight lines as the electric power of the energization of the heater 65 in the case where the reproducing characteristic of the first sector and the reproducing characteristics of the sixth to fifteenth sectors are equal to each other.

Alternatively, the following method may be adopted. That is, the following method may be adopted to obtain the state K2 of FIG. 4. When S1 to S4 are performed while the electric power of the energization of the heater 65 is varied at S1, a certain value is initially set as the electric power of the energization of the heater 65 at S1 to perform S1 to S4. At this point, when the reproducing characteristic of the first sector, obtained as the reproducing characteristic at S4, is better than the reproducing characteristics of the sixth to fifteenth sectors, S1 to S4 are performed while the electric power of the energization of the heater 65 is decreased at S1 in the next time. When the reproducing characteristic of the first sector, obtained as the reproducing characteristic at S4, degrades compared with the reproducing characteristics of the sixth to fifteenth sectors, S1 to S4 are performed while the electric power of the energization of the heater 65 is increased at S1 in the next time. Then, in each time, when the reproducing characteristic of the first sector, obtained as the reproducing characteristic at S4, is better than the reproducing characteristics of the sixth to fifteenth sectors, S1 to S4 are performed while the electric power of the energization of the heater 65 is decreased at S1 in the next time. Then, in each time, when the reproducing characteristic of the first sector, obtained as the reproducing characteristic at S4, degrades compared with the reproducing characteristics of the sixth to fifteenth sectors, S1 to S4 are performed while the electric power of the energization of the heater 65 is increased at S1 in the next time. Therefore, the case in which the reproducing characteristic of the first sector, obtained as the reproducing characteristic at S4, is substantially equal to the reproducing characteristics of the sixth to fifteenth sectors is efficiently obtained.

The detailed flow of the head evaluating method will be described with reference to FIG. 6. The following operations at S13, S14, S15, S16, S17, and S18 of the head evaluating method may automatically be performed by executing a head evaluating program with the personal computer 200.

At S11, as illustrated in FIG. 3, an operator mounts the head 22 and the disk 20 on the spindle motor 110 and the head mounting base 130 of the head evaluating device 100, respectively. At S12, the operator sets the recording coil 58 of the head 22 to an optimum current with the personal computer 200. For example, the optimum current ranges from 30 mA to 40 mA. At S13, a touchdown profile of the head 22 is measured. The measurement of the touchdown profile is described later in addition to FIG. 7.

At S14, the recording current passed through the recording coil 58 of the head 22 is set to 20 mA that is lower by 10 mA than 30 mA of a lower limit of the optimum current. At S15, the electric power is incremented from 0 to 40 mW by a step of 4 mW as the electric power for the conduction of electricity through the heater 65 at S1. The flow of S1 to S4 is performed in each electric power, and VMM1 and VMM2 are measured at S4 in each case. The recording current at S2 and S3 is set to 20 mA as described above. The recorded data has a 200-MHz rectangular wave, and the rectangular wave has amplitude of 20 mA in the case of the recording current of 20 mA.

At S16, the recording current is increased by 10 mA. At S17, it is determined whether the recording current reaches 60 mA. When the recording current reaches 60 mA, the flow goes to S18. When the recording current does not reach 60 mA, the flow returns to S15. That is, the measurement is performed for the recording currents 20, 30, 40, and 50 mA while the recording current expands upward and downward by 10 mA with respect to the optimum current range of 30 to 40 mA. At S15, as described above, the electric power is incremented from 0 to 40 mW by the step of 4 mW as the electric power of the energization of the heater 65 at S1, and S1 to S4 are performed in each electric power. The recording current at S2 and S3 is the value increased at S16. The recorded data has the 200-MHz rectangular wave, and the amplitude of the rectangular wave becomes the value of the increased recording current.

At S18, the values of VMM1 and VMM2 measured at S15 are linearly approximated in each electric power of the energization of the heater 65 at S1, and the intersection point of the obtained straight lines is determined. The electric power of the energization of the heater 65 at S1 is varied in the range of 0 to 40 mA. Therefore, the electric power of the energization of the heater 65 is obtained at the determined intersection point. Then the moving amount (nm/mW) of the head surface 64 with respect to the unit variation in electric power of the energization of the heater 65 is determined based on the touchdown profile measured at S13. The specific moving amount determining method is described later in addition to FIG. 7. The electric power (mW) of the energization of the heater 65 at the determined intersection point is multiplied by the moving amount (nm/mW) of the head surface 64 with respect to the unit variation in electric power of the energization of the heater 65, thereby obtaining the projection amount (nm) in the recording.

The method for determining the moving amount (nm/mW) of the head surface 64 with respect to the unit variation in electric power of the energization of the heater 65 based on the measurement result of the touchdown profile will be described below with reference to FIG. 7.

FIG. 7 is a graph illustrating the state in which an increase in read output corresponding to the increase in projection amount by the increase in electric power of the energization of the heater 65. At S13 of FIG. 6, the head 22 and the disk 20 are mounted on the head evaluating device 100 of FIG. 3, and amplitude (μVpp) (hereinafter referred to as “read output”) of the data read from the disk 20 by the read element 62 is measured while the heater power controller 180 gradually increases the electric power (mW) of the energization of the heater 65. Therefore, the graph of FIG. 7 is obtained.

At this point, it is assumed that V2F is a recording frequency for the data previously recorded in the disk 20. The data previously recorded in the disk 20 is a target read from the disk 20. It is assumed that the recording frequency V2F, a circumferential velocity of the recording track on the disk 20 from which the data is read, a read output V0 in the state in which the electric power of the energization of the heater 65 is 0 mW, a read output Vt at the touchdown point, and an electric power HP of the energization of the heater 65 have the following values.

frequency V2F=200 (MHz)

circumferential velocity=30 (m/sec)

Vt=5600 (μVpp)

V0=3500 (μVpp)

HP=100 (mW)

According to a method for computing “Wallace formula”, a distance ΔSP (that is, spacing amount) between the head surface 64 and the recording surface of the disk 20 is obtained from the following equation:

ΔSP(nm)=V/(2πf)ln(Vt/V0)

Where V is the circumferential velocity and f is the frequency V2F. When the equation is substituted by each value, about 11.2 (nm) is obtained as ΔSP.

ΔSP(mm)=30×10⁹/(2π200×10⁶)·ln(5600/3500)≈11.2

A value in which the obtained ΔSP (nm) is divided by the electric power HP (mW) is the moving amount (nm/mW) of the head surface 64 with respect to the unit variation in electric power of the energization of the heater 65. In the embodiment, the moving amount (nm/mW) of the head surface 64 with respect to the unit variation in electric power of the energization of the heater 65 is determined as follows:

ΔSP/HP=11.2/100=0.112 (nm/mW)

That is, 0.112 (nm/mW) is obtained as the moving amount (nm/mW) of the head surface 64 with respect to the unit variation in electric power of the energization of the heater 65. The electric power of the energization of the heater 65 at the intersection point of the straight lines in which VMM1 and VMM2 obtained at S18 of FIG. 6 are linearly approximated is multiplied by the moving amount (mW) of the head surface 64 with respect to the unit variation in electric power of the energization of the heater 65, which allows the projection amount in the recording to be obtained.

The touchdown point means a state in which the projection amount is increased with increasing electric power of the energization of the heater 65, and whereby the head surface 64 of the head 22 finally comes into contact with the recording surface of the disk 20. There is the following method for obtaining the touchdown point from the graph of FIG. 7. In FIG. 7, the read output, that is, V2F FLEVEL (μVpp) is increased with increasing electric power of the energization of the heater 65, that is, a heater power (mW). The read output is finally saturated, and the read output is not increased even if the electric power of the energization of the heater 65 is increased at the touchdown point. Sometimes the point, at which the read output is finally saturated and the read output is not increased even if the electric power of the energization of the heater 65 is increased, is not clearly determined. In such cases, the following method may be adopted. In a process for gradually increasing the electric power of the energization of the heater 65 from 0 (mW), the intersection point of the ever-increasing straight line in a period during which the read output is linearly increased and the horizontal straight line in the state in which the read output is saturated after that to become constant may be obtained as the touchdown point.

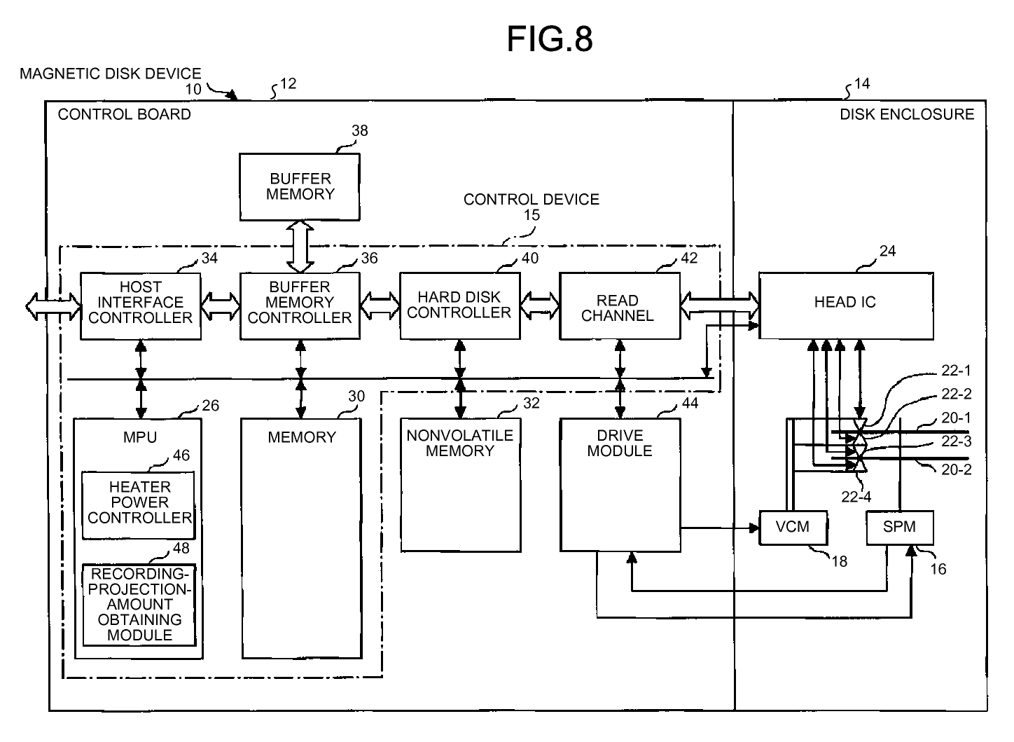

FIG. 8 is a block diagram illustrating a magnetic disk device that is of an embodiment of the information storage apparatus. For example, the magnetic disk device 10 has the structure of FIG. 1. Referring to FIG. 8, the magnetic disk device 10, known as a Hard Disk Drive (HDD), comprises a disk enclosure 14 and a control board 12. The spindle motor (SPM) 16 is provided in the disk enclosure 14, and disks (medium) 20-1 and 20-2 are attached to a rotating shaft of the spindle motor 16 and rotated at a constant speed, for example, 4200 rpm.

The voice coil motor (VCM) 18 is provided in the disk enclosure 14. In the voice coil motor 18, heads 22-1 to 22-4 are mounted at a leading end of an arm of a head actuator. The voice coil motor 18 performs head positioning with respect to the recording surfaces of the disks 20-1 and 20-2. The recording elements and the read elements are integrally mounted on the heads 22-1 to 22-4.

The heads 22-1 to 22-4 are connected to a head IC 24 through a signal line. In the head IC 24, one of the heads 22-1 to 22-4 is selected by a head select signal based on a write command or a read command, transmitted from a host that is of a higher-level device, and the recording or the read is performed. In the head IC 24, a write amplifier is provided in a write system, and a preamplifier is provided in a read system.

An MPU 26 is provided in the control board 12, and a memory 30 in which RAM is used and a nonvolatile memory 32 in which FROM is used are provided to a bus 28 of the MPU 26. A control program and control data are stored in the memory 30. A control program is stored in the nonvolatile memory 32.

A host interface controller 34, a buffer memory controller 36, a hard disk controller 40, a read channel 42, and a drive module 44 are provided in the bus 28 of the MPU 26. The buffer memory controller 36 controls a buffer memory 38. The read channel 42 acts as a write modulation module and a read demodulation module. The drive module 44 controls the voice coil motor 18 and the spindle motor 16.

The MPU 26, the memory 30, the host interface controller 34, the buffer memory controller 36, the hard disk controller 40, and the read channel 42 in the control board 12 can be formed as one control device 15. Specifically, the control device 15 is formed as one LSI device.

The magnetic disk device 10 performs write processing and read processing based on a command from the host. The usual operation of the magnetic disk device 10 will be described below.

The host interface controller 34 receives the write command and the write data from the host, the MPU 26 decodes the write command, and the received write data is stored in the buffer memory 38 if needed. Then the hard disk controller 40 converts the write data into a predetermined data format, and an ECC code is added to the write data through ECC processing. The write modulation system in the read channel 42 performs scrambling, RLL code conversion, and write compensation to the write data. Then, for example, the write data is recorded in the magnetic disk 20 using the recording element of the head 22-1 selected by the write amplifier through the head IC 24.

At this point, the MPU 26 supplies a head positioning signal to the drive module 44 including the VCM motor driver, the seeks the target track directed by the command using the voice coil motor 18, and the head is positioned on the target track to perform tracking control.

On the other hand, when the host interface controller 34 receives the read command from the host, the MPU 26 decodes the read command. The read element of the head 22-1 selected by the head select signal of the head IC 24 reads the read signal, and the preamplifier amplifies the read signal. Then the read signal is fed into the read demodulation system of the read channel 42, the read data is demodulated by Partial Response Maximum Likelihood (PRML), and the hard disk controller 40 performs the ECC processing to detect and correct the error. Then the read data is buffered in the buffer memory 38, and the host interface controller 34 transmits the read data to the host.

The MPU 26 comprises a heater power controller 46 and a recording-projection-amount obtaining module 48. The heater power controller 46 and the recording-projection-amount obtaining module 48 are realized by executing a program. As with the head 22 of FIG. 2B, the heads 22-1 to 22-4 comprise the read elements 62 and the recording elements 63. As with the head 22 of FIG. 2B, the heaters 65 are provided in the heads 22-1 to 22-4, and the heater 65 changes the projection amount by the thermal expansion caused by the electric heating.

The heater power controller 46 has the function similar to that of the heater power controller 180 comprised in the head evaluating device 100 of FIG. 3. The recording-projection-amount obtaining module 48 has the function of automatically performing the operations at S12 to S18 of the flowchart of FIG. 6. In FIG. 6, the operations at S12 to S18 are performed by the personal computer 200 that controls the head evaluating device 100. In the magnetic disk device 10 of FIG. 8, the functions of the head IC 24, the control device 15, the nonvolatile memory 32, the drive module 44, and the SPM 16 are appropriately utilized in performing the operations at S12 to S18. As a result, in the magnetic disk device 10 of FIG. 8, the head evaluating method of FIGS. 3 to 7 is automatically performed to determine the projection amount of the heads 22-1 to 22-4 in the recording.

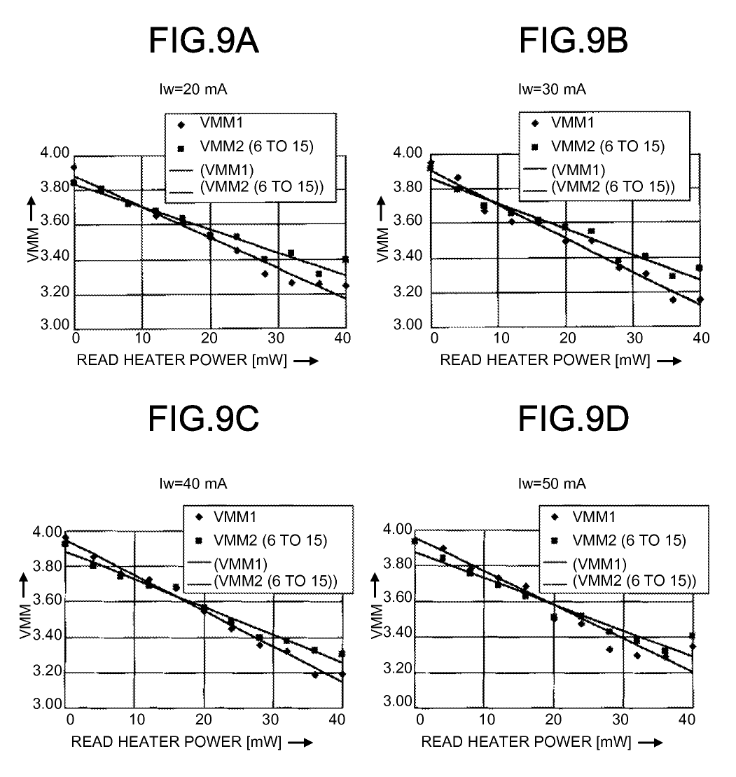

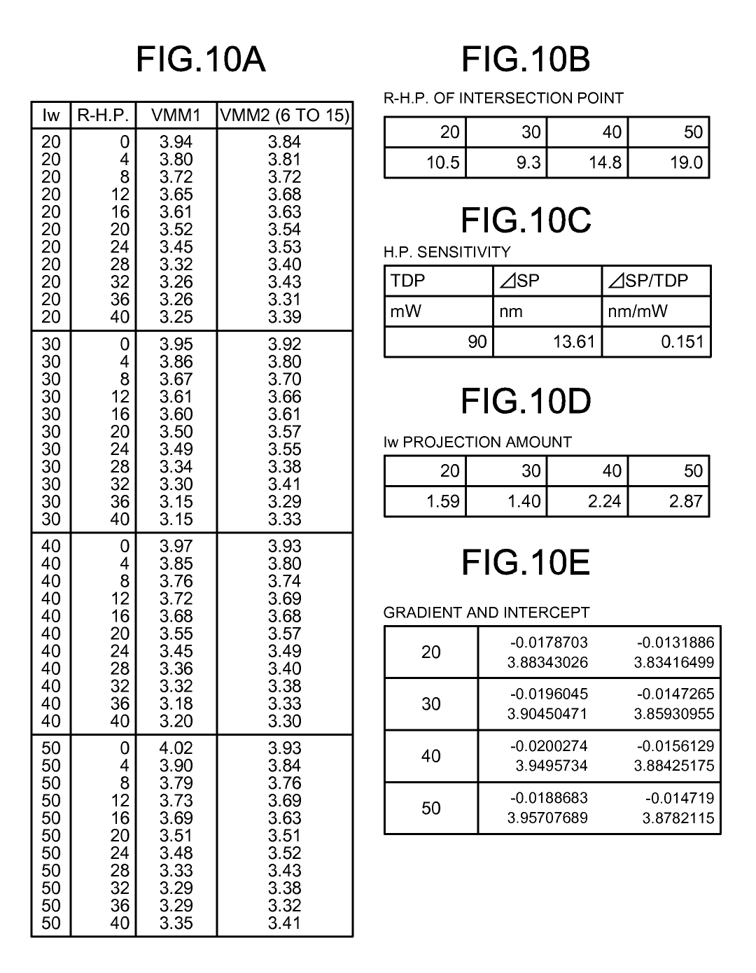

Experimental results obtained by performing the head evaluating method of FIG. 6 with the head evaluating device 100 of FIG. 3 will be described below with reference to FIGS. 9A to 9D and 10A to 10E.

FIGS. 9A to 9D illustrate pieces of experimental data obtained by performing S15 of FIG. 6 for the recording currents of 20 mA, 30 mA, 40 mA, and 50 mA. In each graph of FIGS. 9A to 9D, the horizontal axis indicates the electric power (mW) of the energization of the heater 65 at S1, and the horizontal axis indicates VMM1 or VMM2. In FIGS. 9A to 9D, the numerals “VMM1” and “VMM2(6-15)” designate measurement results of VMM1 and VMM2. In each graph of FIGS. 9A to 9D, the two straight lines intersecting each other are obtained by linearly approximating the measurement values of VMM1 and VMM2.

FIG. 10A illustrates measurement values that are of the basis for the graphs of FIGS. 9A to 9D. The letter Iw designates the recording current, the letter R-H.P. designates the electric power (mW) of the energization of the heater 65 at S1, and the numerals “VMM1” and “VMM2(6-15)” designate measurement results of VMM1 and VMM2.

FIG. 10B illustrates the electric power (mW) of the energization of the heater 65 at the intersection point for the recording current of 20 to 50 mA.

In FIG. 10C, the letter TDP designates the electric power (mW) of the energization of the heater 65 at the touchdown point, the letter ΔSP designates the distance ΔSP (nm), and the letter ΔSP/TDP designates the moving amount (nm/mW) of the head surface 64 with respect to the unit variation in electric power of the energization of the heater 65.

FIG. 10D illustrates the projection amount (nm) in the recording for the recording current of 20 to 50 mA. The projection amount is a value obtained by multiplying the value of ΔSP/TDP of FIG. 10C by the electric power (mW) of the energization of the heater 65 at the intersection point of FIG. 10B.

FIG. 10E illustrates values of a gradient and a vertical intercept of the straight lines in which the measurement values of VMM1 and VMM2 of FIGS. 9A to 9D are linearly approximated in each recording current of 20 to 50 mA.

According to an embodiment of the invention, a predetermined power value of a heater for which a reproduction characteristic of a first sector becomes equal to a reproduction characteristic of a second sector is found to obtain a projection amount upon the recording from the power value. Therefore, it is possible to obtain the projection amount upon the recording accurately.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. Ahead evaluating method for a head comprising a read element, a recording element, a recording coil through which a recording electric current is supplied upon recording by the read element, and a heater configured to change a projection amount of the read element and recording element with respect to a medium by thermal expansion caused by electric heating, the head evaluating method comprising:
floating the head over the medium rotated;
projecting comprising
conducting electricity through the heater with a predetermined electric power, and
projecting the read element and the recording element toward the medium;
first recording comprising
stopping the conduction of electricity through the heater, and
recording data in a first sector on the medium after the stopping the conduction of electricity;
second recording of recording data in a second sector on the medium away from the first sector by a predetermined number of at least one sector;
reproducing the data recorded in the first sector and second sector in order to compute reproducing characteristics of the data recorded in the first sector and the data recorded in the second sector; and
computing a projection amount upon recording, comprising
repeating the projecting, the first recording, the second recording, and the reproducing, while changing the predetermined electric power in the projecting,
computing the predetermined electric power for the heater at which the reproducing characteristic of the first sector becomes substantially equal to the reproducing characteristic of the second sector, and
computing a projection amount of the read element and recording element with respect to the medium due to the recording electric current supplied through the recording coil upon recording based on the computed electric power.

2. The head evaluating method of claim 1, wherein the computing the projection amount upon recording comprises:
computing an amount of the predetermined electric power for the heater at which the reproducing characteristic of the first sector becomes substantially equal to the reproducing characteristic of the second sector by repeating the projecting, the first recording, the second recording, and the reproducing, while using a decreased amount of the predetermined electric power in the projecting, if the reproducing characteristic of the first sector is better than the reproducing characteristic of the second sector, and
computing an amount of the predetermined electric power for the heater at which the reproducing characteristic of the first sector becomes substantially equal to the reproducing characteristic of the second sector by repeating the projecting, the first recording, the second recording, and the reproducing, while using an increased amount of the predetermined electric power in the projecting, if the reproducing characteristic of the first sector is worse than the reproducing characteristic of the second sector.

3. The head evaluating method of claim 1, comprising obtaining a touchdown profile indicative of a relationship between the electric power supplied to the heater and a relative position of the read element and recording element with respect to the medium, by measuring the projection amount of the read element and recording element with respect to the medium upon the conducting of electricity through the heater, wherein,
the computing the projection amount upon recording comprises conversion based on the touchdown profile into the projection amount of the read element and recording element with respect to the medium upon supplying through the recording coil a recording electric current from the predetermined electric power for the heater at which the reproducing characteristic of the first sector becomes substantially equal to the reproducing characteristic of the second sector.

4. The head evaluating method of claim 1, wherein the reproducing characteristics comprise at least one of a reproduced signal characteristic and an error characteristic.

5. A head evaluating device for a head comprising a read element, a recording element, a recording coil through which a recording electric current is supplied upon recording by the read element, and a heater configured to change a projection amount of the read element and recording element with respect to a medium by thermal expansion caused by electric heating, the head evaluating device comprising:
a heater power controller configured to conduct electricity thorough the heater;
a reproducing and recording controller configured to reproduce data from the medium or to record data on the medium, using the head; and
a projection-amount-upon-recording computing module configured to compute a projection amount of the read element and recording element with respect to the medium due to the recording electric current supplied through the recording coil upon recording;
wherein the projection-amount-upon-recording computing module is configured to:
stop the conduction of electricity through the heater after causing the heater power controller to conduct electricity through the heater with a predetermined electric power in order to project the read element and recording element toward the medium,
cause the reproducing and recording controller to record data in a first sector on the medium after stopping the conduction of electricity and to record data in a second sector away from the first sector by a predetermined number of at least one sector, and reproduce the data recorded in the first sector and second sector in order to compute a reproducing characteristic of the first sector and a reproducing characteristic of the second sector, and
compute the predetermined electric power for the heater at which the reproducing characteristic of the first sector becomes substantially equal to the reproducing characteristic of the second sector, and compute the projection amount of the read element and recording element with respect to the medium due to the recording electric current supplied through the recording coil upon recording, based on the computed electric power.

6. The head evaluating device of claim 5, wherein,
the projection-amount-upon-recording computing module is configured to compute the predetermined electric power for the heater at which a reproducing characteristic of the first sector becomes substantially equal to a reproducing characteristic of the second sector, if the reproducing characteristic of the first sector is better than the reproducing characteristic of the second sector, by repeating:
decreasing the predetermined electric power for the heater and conducting electricity through the heater with the decreased amount of the predetermined electric power to project the read element and recording element toward the medium,
stopping the conduction of electricity through the heater,
recording data in the first sector on the medium after the stopping the conduction of electricity and in the second sector, and
computing the reproducing characteristic of the first sector and the reproducing characteristic of the second sector, and
the projection-amount-upon-recording computing module is configured to compute the predetermined electric power for the heater at which a reproducing characteristic of the first sector becomes substantially equal to a reproducing characteristic of the second sector, if the reproducing characteristic of the first sector is worse than the reproducing characteristic of the second sector, by repeating:
increasing the predetermined electric power for the heater and conducting electricity through the heater with the increased amount of the predetermined electric power to project the read element and recording element toward the medium,
stopping the conduction of electricity through the heater,
recording data in the first sector on the medium after the stopping the conduction of electricity and in the second sector, and
computing the reproducing characteristic of the first sector and the reproducing characteristic of the second sector.

7. The head evaluating device of claim 5, wherein the projection-amount-upon-recording computing module is configured to:
obtain a touchdown profile indicative of a relationship between the electric power supplied to the heater and a relative position of the read element and recording element with respect to the medium, by measuring the projection amount of the read element and recording element with respect to the medium upon the conducting of electricity through the heater, and
convert based on the touchdown profile into the projection amount of the read element and recording element with respect to the medium upon supplying through the recording coil a recording electric current from the predetermined electric power for the heater at which the reproducing characteristic of the first sector becomes substantially equal to the reproducing characteristic of the second sector.

8. The head evaluating device of claim 5, wherein the reproducing characteristics comprise at least one of a reproduced signal characteristic and an error characteristic.

9. An information storage apparatus comprising a head comprising a read element, a recording element, a recording coil through which a recording electric current is supplied upon recording by the read element, and a heater configured to change a projection amount of the read element and recording element by thermal expansion caused by electric heating, the head evaluating device comprising:
a heater power controller configured to conduct electricity thorough the heater;
a reproducing and recording controller configured to reproduce data from a medium or to record data on the medium, using the head; and
a projection-amount-upon-recording computing module configured to compute a projection amount of the read element and recording element with respect to the medium due to the recording electric current supplied through the recording coil upon recording;
wherein the projection-amount-upon-recording computing module is configured to:
stop the conduction of electricity through the heater after causing the heater power controller to conduct electricity through the heater with a predetermined electric power in order to project the read element and recording element toward the medium,
cause the reproducing and recording controller to record data in a first sector on the medium after stopping the conduction of electricity and to record data in a second sector away from the first sector by a predetermined number of at least one sector, and reproduce the data recorded in the first sector and second sector in order to compute a reproducing characteristic of the first sector and a reproducing characteristic of the second sector, and
compute the predetermined electric power for the heater at which the reproducing characteristic of the first sector becomes substantially equal to the reproducing characteristic of the second sector, and compute the projection amount of the read element and recording element with respect to the medium due to the recording electric current supplied through the recording coil upon recording, based on the obtained electric power.

10. The information storage apparatus of claim 9, wherein,
the projection-amount-upon-recording computing module is configured to compute the predetermined electric power for the heater at which a reproducing characteristic of the first sector becomes substantially equal to a reproducing characteristic of the second sector, if the reproducing characteristic of the first sector is better than the reproducing characteristic of the second sector, by repeating:
decreasing the predetermined electric power for the heater and conducting electricity through the heater with the decreased amount of the predetermined electric power to project the read element and recording element toward the medium,
stopping the conduction of electricity through the heater,
recording data in the first sector on the medium after the stopping the conduction of electricity and in the second sector, and
computing the reproducing characteristic of the first sector and the reproducing characteristic of the second sector, and
the projection-amount-upon-recording computing module is configured to compute the predetermined electric power for the heater at which a reproducing characteristic of the first sector becomes substantially equal to a reproducing characteristic of the second sector, if the reproducing characteristic of the first sector is worse than the reproducing characteristic of the second sector, by repeating:
increasing the predetermined electric power for the heater and conducting electricity through the heater with the increased amount of the predetermined electric power to project the read element and recording element toward the medium,
stopping the conduction of electricity through the heater,
recording data in the first sector on the medium after the stopping the conduction of electricity and in the second sector, and
computing the reproducing characteristic of the first sector and the reproducing characteristic of the second sector.

11. The information storage apparatus of claim 9, wherein the projection-amount-upon-recording computing module is configured to:
obtain a touchdown profile indicative of a relationship between the electric power supplied to the heater and a relative position of the read element and recording element with respect to the medium, by measuring the projection amount of the read element and recording element with respect to the medium upon the conducting of electricity through the heater, and
convert based on the touchdown profile into the projection amount of the read element and recording element with respect to the medium upon supplying through the recording coil a recording electric current from the predetermined electric power for the heater at which the reproducing characteristic of the first sector becomes substantially equal to the reproducing characteristic of the second sector.

12. The information storage apparatus of claim 9, wherein the reproducing characteristics comprise at least one of a reproduced signal characteristic and an error characteristic.
